(19) United States
(12) Patent Application Publication
(10) Pub. No.: US 2008/0158887 A1
(43) Pub. Date: Jul. 3, 2008

(54) LIGHT-EMITTING DIODE LAMP

(75) Inventors: Ming-Wu Zhu, Shenzhen (CN); Li-Kuang Tan, Tu-Cheng (TW); Yeu-Lih Lin, Tu-Cheng (TW); Tseng-Hsiang Hu, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Tu-Cheng (TW)

(21) Appl. No.: 11/674,358

(22) Filed: Feb. 13, 2007

(30) Foreign Application Priority Data
Dec. 29, 2006 (CN) 200610064615.6

(51) Int. Cl. F21V 29/00; B60Q 1/06

(52) U.S. Cl. 362/294; 362/373

(57) ABSTRACT

A light-emitting diode (LED) includes a heat sink (10) having a cross section along an axial direction thereof being U-shaped. The heat sink includes a substrate (102) and a sidewall (11) extending from an outer periphery of the substrate. A circuit board (40) is received in the heat sink and arranged on the substrate. At least one LED (30) is arranged on and electrically connected to the circuit board and thermally connected with the substrate of the heat sink. A plurality of fins (100) extend outwardly from an outer surface (110) of the sidewall of the heat sink. Each fin has a plurality of branches (100a, 100b) being connected together at the outer surface of the sidewall and being spaced from each other at outer-peripheries thereof.

### BACKGROUND OF THE INVENTION

1. Field of the Invention

The present invention relates generally to light-emitting diode (LED) lamps, and more particularly to an LED lamp with improved heat dissipation ability so that heat generated by the LEDs can be effectively removed.

2. Description of Related Art

Light-emitting diodes (LEDs) are highly efficient light sources currently used widely in such fields as automobiles, screen displays, and traffic light indicators. When the LED gives off light, heat is also produced. If not rapidly and efficiently removed, the heat produced may significantly reduce the lifespan of the LED. Therefore, a heat dissipation device is required to dissipate the heat from the LED.

FIG. 6 is a cross-sectional view of an LED lamp 620 in accordance with related art. The LED lamp 620 includes an LED die 621, an outer packaging layer 622, and a pair of conductive pins 624, 625. The LED die 621, which is placed in a recess defined in the conductive pin 625, is protectively packaged and secured in place via the packaging layer 622. The conductive pins 624, 625 extend downwardly from the LED die 621, giving the LED lamp 620 a stand-up configuration. In this particular example, it is difficult to combine a heat dissipation device to the LED lamp 620 since an interference problem arises between the conductive pins 624, 625 and the heat dissipation device when combined. The heat dissipation device needs to sacrifice a large portion of its heat transfer surface area in order to accommodate and mount the conductive pins 624, 625.

FIG. 7 shows another LED lamp in accordance with related art. The LED lamp includes an LED 710 having a pair of conductive pins 714 extending laterally and outwardly from opposite sides thereof. The LED 710 is mounted within a through hole 721 defined in a circuit board 712, and a flat bottom surface of the LED 710 is maintained in thermal contact with a metal plate 713 placed under the circuit board 712. The LED 710 is electrically connected to the circuit board 712 via the conductive pins 714. When the LED 710 gives off light, a large amount of heat is generated. The heat generated by the LED 710 of the LED lamp is transferred to the metal plate 713 for dissipation. However, a heat dissipation area of the metal plate 713 is limited. For enhancing the heat dissipation effectiveness of this LED lamp, a heat dissipation area of the LED lamp needs to be increased.

Therefore, it is desirable to provide an LED lamp wherein one or more of the foregoing disadvantages may be overcome or at least alleviated.

### SUMMARY OF THE INVENTION

The present invention relates to a light-emitting diode (LED) lamp. The LED lamp includes a heat sink having a cross section along an axial direction thereof being U-shaped. The heat sink includes a substrate and a sidewall extending from an outer periphery of the substrate. A circuit board is received in the heat sink and arranged on the substrate. At least one LED is arranged on and electrically connected to the circuit board. The at least one LED is thermally connected with the substrate of the heat sink. A plurality of fins extend outwardly from an outer surface of the sidewall of the heat sink. Each fin has a plurality of branches with inner sides being connected together at the outer surface of the sidewall and outer sides being spaced from each other except at a bottom end of the outer surface of the sidewall of the heat sink.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present light-emitting diode (LED) lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views:

FIG. 1 is an assembled, isometric view of an LED lamp in accordance with a preferred embodiment of the present invention;

FIG. 2 is an explored view of the LED lamp of FIG. 1;

FIG. 3 is a cross-sectional view of the LED lamp of FIG. 1 taken along line III-III;

FIG. 4 is similar to FIG. 3, but showing a cross-sectional view of the LED lamp of FIG. 1 taken along line IV-IV;

FIG. 5 is a bottom view of a heat sink of the LED lamp of FIG. 1;

FIG. 6 is a cross-sectional view of an LED lamp in accordance with related art; and

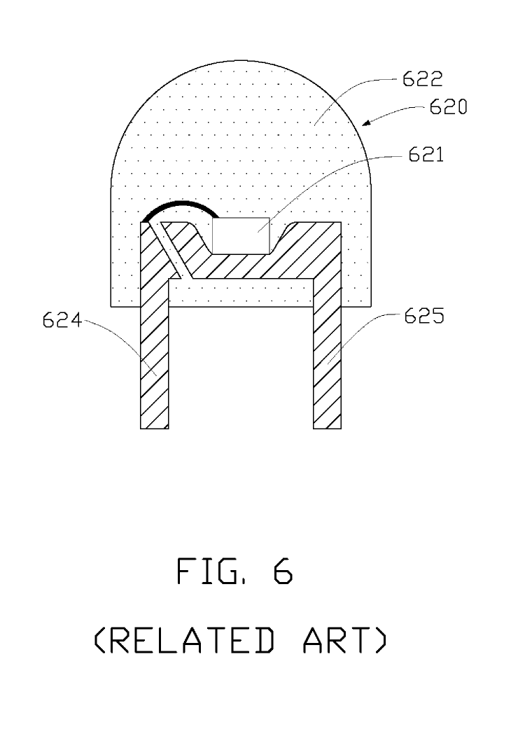

FIG. 7 is an exploded, isometric view of another LED lamp in accordance with related art.

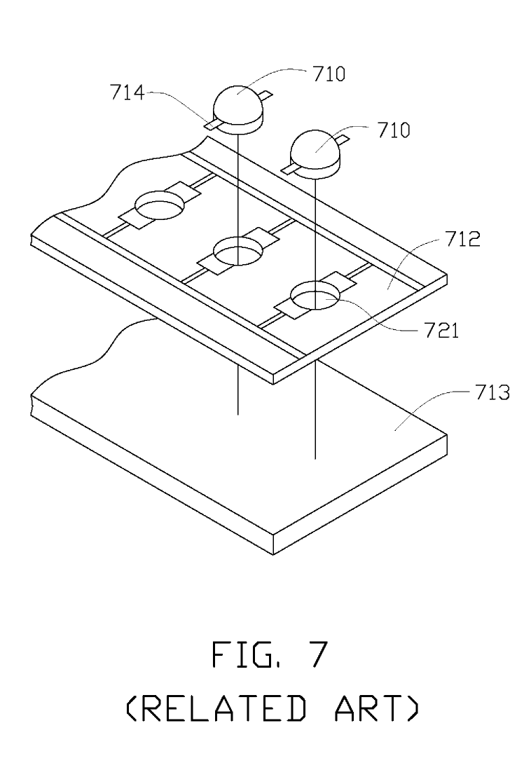

### DETAILED DESCRIPTION OF THE INVENTION

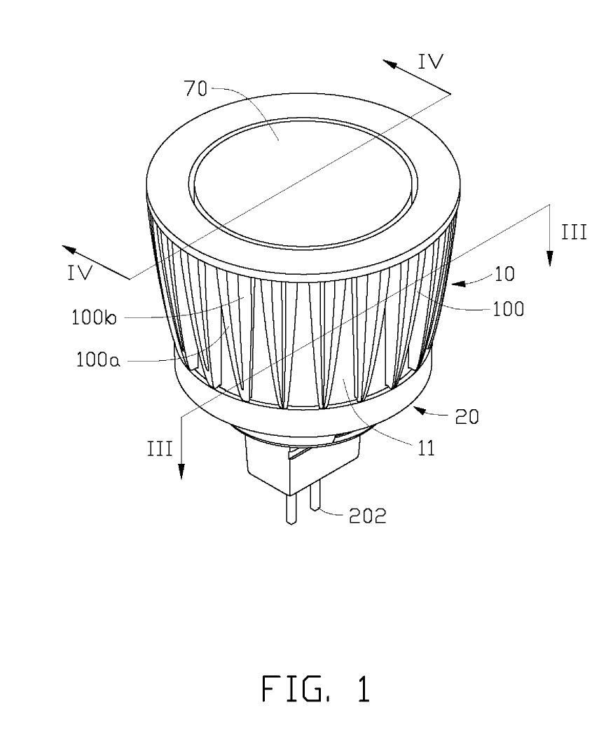

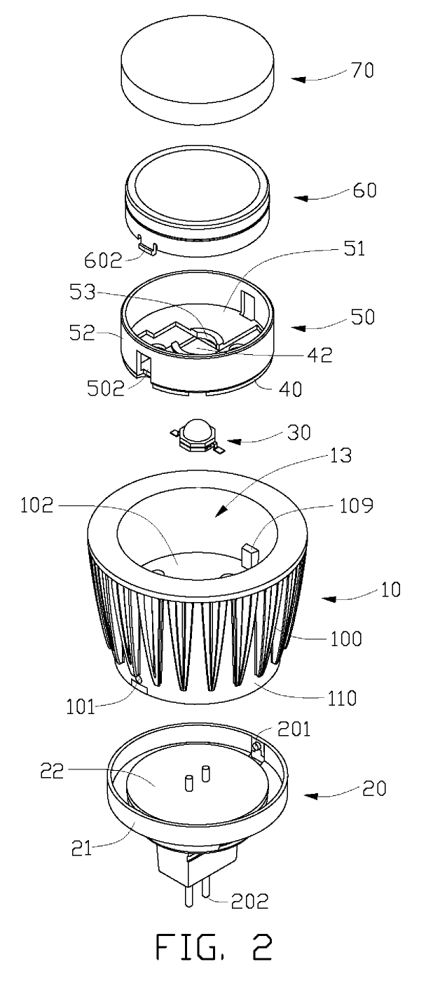

FIGS. 1-2 illustrate a light-emitting diode (LED) lamp in accordance with a preferred embodiment of the present invention. The LED lamp includes a heat sink 10, a lamp holder 20, an LED 30, a circuit board 40, a bracket 50, a reflector 60 and a lampshade 70.

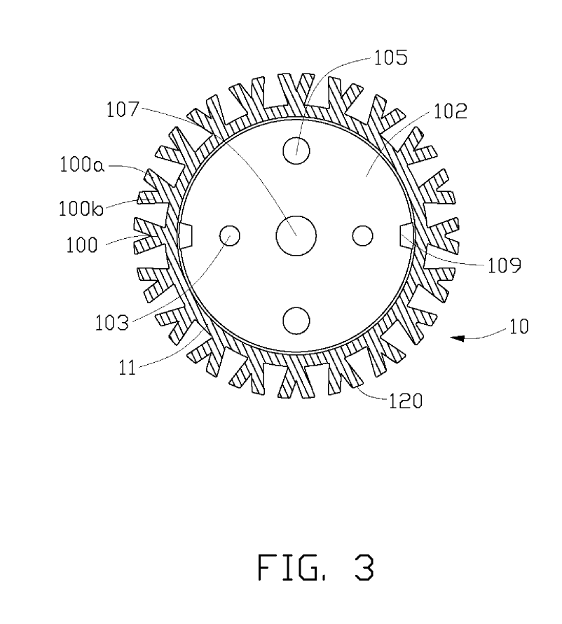

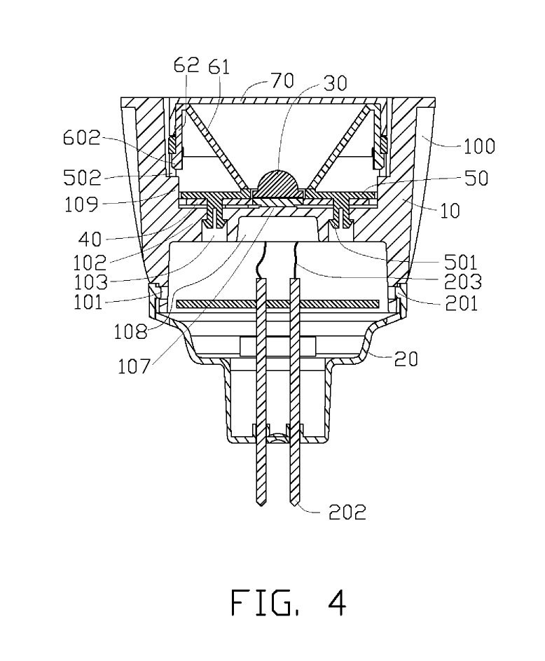

Referring to FIG. 3-5, the heat sink 10 is made of aluminum alloy. Alternatively, the heat sink 10 can be made of other materials of high heat conductivity, such as copper and stainless steel. The heat sink 10 is truncated cone-shaped. An outer diameter of the heat sink 10 gradually increases along an axial direction from a bottom end to a top end thereof. The top end of the heat sink 10 is open, whilst the bottom end of the heat sink 10 is closed. A cross section of the heat sink 10 along the axial direction thereof is approximately U-shaped (as shown in FIG. 4). The heat sink 10 includes a circular-shaped substrate 102, and a cylindrical-shaped sidewall 11 extending upwardly from an outer periphery of the substrate 102. Cooperatively the substrate 102 and the sidewall 11 define a space 13 therein. A bulge 107 extends from a central portion of an upper side of the substrate 102 for the LED 30 to be mounted thereon. A concave 108 is defined in a lower side of the substrate 102 corresponding to the bulge 107. A pair of through holes 105 are defined in the substrate 102 around the bulge 107. A pair of securing holes 103 are defined in the substrate 102 for securing the bracket 50. The through holes 105 and the securing holes 103 are evenly spaced from each other and are alternatively arranged along a circumferential direction of the substrate 102. Two blocks 109 extend inwardly from an inner surface of the sidewall 11. The blocks 109 are formed on the bottom end of the sidewall 11, and are located above and adjacent to the upper side of the substrate 102. The blocks 109 are symmetrical to each other, and are aligned with the securing holes 103. A pair of traverse holes 101 are defined in the bottom of an outer surface 110 of the sidewall 11.

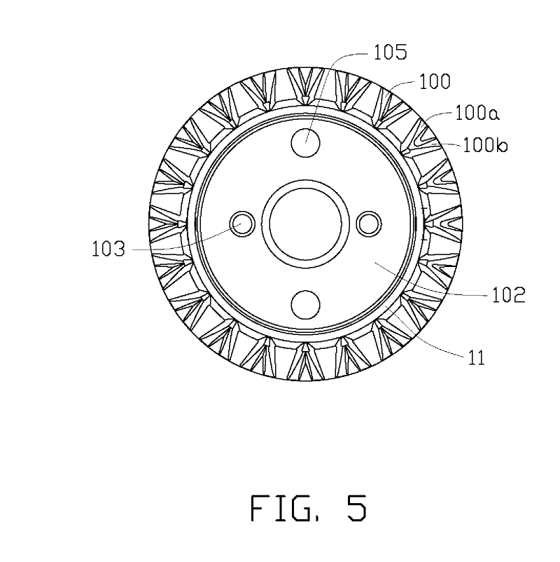

A plurality of fins 100 extend radially and outwardly from the outer surface 110 of the sidewall 11. The fins 100 are integrally formed with the heat sink 10 and are evenly spaced from each other along a circumferential direction of the sidewall 11 of the heat sink 10. Each fin 100 is V-shaped, and includes a first branch 100a and a second branch 100b. Each branch 100a, 100b is planar-shaped. A width of the branch 100a, 100b is gradually increased from the bottom end to the top end of the heat sink 10. Outer sides 120 (FIG. 3) of the two branches 100a, 100b of each fin 100 are connected with each other at the bottom end of the heat sink 10, and are spaced from each other at portion of the heat sink 10 other than the bottom end thereof. The spaced distance increases along a direction from the bottom end to the top end of the heat sink 10. In addition, as shown in FIGS. 3 and 5, each fin 100 has a V-shaped cross section taken along a radial direction of the heat sink 10. Inner sides (not labeled) of the first and second branches 100a, 100b connect with each other at the outer surface 110 of the sidewall 11. A distance between the branches 100a, 100b of each fin 100 is similar to each other, while the fins 100 are substantially evenly spaced from each other. Accordingly, the fins 100 of the present invention can have a heat-dissipation area which is twice as large as that obtainable by the conventional planar-shaped, single-branched fins which are spaced from each other a distance the same as the spaced distance between the two neighboring fins 100 of the present invention measured at the outer surface 110 of the sidewall 11 of the heat sink 10. The shape of the branches 100a, 100b of the fins 100 is not limited. The branches 100a, 100b can be wave-shape, which can further increase the area of the fins 100. Alternatively, each fin 100 can have a single plate-like inner portion and an outer portion formed with V-shaped branches so that each fin 100 has a Y-shaped configuration. Also each fin 100 can have more branches 100a, 100b, such as three branches.

The lamp holder 20 is approximately disk-shaped, and connects to the bottom end of the heat sink 10. The lamp holder 20 includes a circular-shaped base 21 and a cylinder 22 extending upwardly from an outer periphery of the base 21. The lamp holder 20 is made by plastic injection. A pair of pins 202 extend through the base 21 and are fixedly assembled on the lamp holder 20. Two poles 201 extend inwardly from the cylinder 22 of the lamp holder 20 corresponding to the traverse holes 101 of the sidewall 11 of the heat sink 10. When the lamp holder 20 is assembled on the heat sink 10, the cylinder 22 of the lamp holder 20 is mounted around the bottom end of the sidewall 11 with the poles 201 received in the traverse holes 101. The base 21 of the lamp holder 20 faces the substrate 102 of the heat sink 10. Conducting wires 203 electrically connect top ends of the pins 202 and the circuit board 40. Bottom ends of the pins 202 are electrically connected with a power source to apply current to the LED 30 which is electrically connected to the circuit board 40.

The circuit board 40 is arranged on the substrate 102 of the heat sink 10. An aperture 42 is defined in the circuit board 40 corresponding to a position of the bulge 107 of the substrate 102. The LED 30 is arranged on the bulge 107 fixedly through soldering or adhesive, and extends through the aperture 42 of the circuit board 40. The LED 30 is electrically connected to the circuit board 40 through wire bonding or flip chip. The bracket 50 is received in the space 13 and arranged on the circuit board 40. The bracket 50 includes a chassis 51 and a lateral wall 52. The chassis 51 is circular-shaped, and has an outer diameter approximately equal to an inner diameter of the sidewall 11 of the heat sink 10. A central hole 53 is defined in the chassis 51 corresponding to the aperture 42 of the circuit board 40 for extension of the LED 30 therethrough. Two securing posts 501 extend downwardly from the bracket 50. Each post 501 forms a barb (not labeled) at a free end thereof. The circuit board 40 defines two openings (not labeled) corresponding to the posts 501 of the bracket 50. When assembled the posts 501 extend through the openings into the securing holes 103 and abut against the lower side of the substrate 102 to fix the circuit board 40, the bracket 50 and the heat sink 10 together. Thus movement of the circuit board 40 along the axial direction of the heat sink 10 is limited. The lateral wall 52 extends upwardly from an outer periphery of the chassis 51. A pair of mounting holes 502 are defined in the lateral wall 52 corresponding to the blocks 109 of the heat sink 10 and receive the blocks 109 therein to limit rotation of the bracket 50.

The reflector 60 is received in the bracket 50 and mounted around the LED 30. The reflector 60 includes an inner wall 61 having a shape of bowl and a cylindrical-shaped outer wall 62 extends downwardly from a top end of the inner wall 61. The bottom and top ends of the inner wall 61 are open. A diameter of the inner wall 61 gradually increases from the bottom end to the top end thereof. A pair of hooks 602 extend outwardly from the outer wall 62 corresponding to the mounting holes 502 of the lateral wall 52 of the bracket 50. When assembled the bottom end of the inner wall 61 abuts the chassis 51 of the bracket 50, and the hooks 602 engage in the mounting holes 502 to fix the reflector 60 and the bracket 50 together. The lampshade 70 is mounted on the top end of the reflector 60 to encapsulate the LED 30.

During assembly, the LED 30 is fixedly mounted on the bulge 107 of the heat sink 10 and is electrically connected with the circuit board 40. The poles 201 of the lamp holder 20 lock in the traverse holes 101 to lock the lamp holder 20 to the heat sink 10. The circuit board 40, the bracket 50, the reflector 60, and the lampshade 70 are stacked in the space 13 of heat sink 10 one on top of the other in sequence. The posts 501 of the bracket 50 extend through the securing holes 103 of the heat sink 10 and thus fix the bracket 50 to the heat sink 10. Conducting wires 203 extend through the through holes 105 to connect the circuit board 40 to the pins 202 of the lamp holder 20. During operation, the bottom ends of the pins 202 are electrically connected with the power source to apply current to the LED 30. When the LED 30 operates to give off light, heat is accordingly produced. The heat generated by the LED 30 is transferred to the substrate 102 of the heat sink 10 and then to the sidewall 11 and the fins 100 to dissipate. Since the fins 100 can increase the heat dissipation area of the heat sink 10 enormously, the heat of the LED 30 can be dissipated to the surrounding environment rapidly and efficiently. In this way the heat of the LED 30 can be quickly removed, thus significantly improving lifespan of the LED 30. In this embodiment, only one LED 30 is shown. Alternatively, there can be several LEDs 30 mounted on the substrate of the heat sink 10 of the LED 30 lamp, and the fins 100 can remove the heat of the LEDs 30 quickly and increase the overall brightness and lifespan of the LEDs 30.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light-emitting diode (LED) lamp, comprising:
a heat sink having a cross section along an axial direction thereof being U-shaped, comprising a substrate and a sidewall extending from an outer periphery of the substrate;
a circuit board being received in the heat sink and arranged on the substrate;
at least one LED being arranged on and electrically connected to the circuit board, the at least one LED being thermally connected to the substrate; and
a plurality of fins extending outwardly from an outer surface of the sidewall of the heat sink; each fin having a plurality of branches, the branches of each fin being connected together at the outer surface of the sidewall and being spaced from each other at outer-peripheries thereof.

2. The LED lamp of claim 1, wherein the fins are integrally formed with the heat sink.

3. The LED lamp of claim 1, wherein each fin comprises two branches, and is one of V-shaped and Y-shaped.

4. The LED lamp of claim 1, wherein the branches of each fin are connected together at one end of the heat sink, and are spaced from each other except at the one end of the heat sink.

5. The LED lamp of claim 1, wherein each branch of each of the fins has a width which is gradually increased along the axial direction of the heat sink.

6. The LED lamp of claim 1, further comprising a bracket arranged on the circuit board and engaging with the heat sink to limit movement of the circuit board along the axial direction of the heat sink, the bracket defining a central hole for extension of the at least one LED therethrough.

7. The LED lamp of claim 6, wherein the substrate of the heat sink defines a plurality of securing holes therein, and the bracket forms a plurality pins engaging into the securing holes to assemble the bracket and the heat sink together.

8. The LED lamp of claim 6, wherein the sidewall of the heat sink has a plurality of blocks extending inwardly from an inner surface thereof, and the bracket defines a plurality of mounting holes receiving the blocks therein to limit rotation of the bracket.

9. The LED lamp of claim 8, further comprising a reflector arranged on the bracket, the reflector forming a plurality of hooks locking in the mounting holes of the bracket to fix the reflector to the bracket.

10. The LED lamp of claim 1, further comprising a lamp holder, the lamp holder having two pins being electrically connected to the circuit board for electrically connecting the LED to a power source.

11. The LED lamp of claim 10, wherein the sidewall of the heat sink defines a plurality of traverse holes in the outer surface thereof, and the lamp holder forms a plurality of poles locking in the traverse holes to fix the lamp holder to the heat sink.

12. A light-emitting diode (LED) lamp, comprising:
a heat sink having a cross section along an axial direction thereof being U-shaped, comprising a substrate and a sidewall extending from an outer periphery of the substrate, a plurality of fins extending outwardly from an outer surface of the sidewall of the heat sink;
each fin having a plurality of branches, the branches of each fin being connected together at the outer surface of the sidewall and being spaced from each other at outer peripheries thereof;
a circuit board being received in the heat sink and arranged on the substrate;
at least one LED being arranged on and electrically connected to the circuit board and being thermally connected with the substrate of the heat sink;
a bracket being arranged on the circuit board and engaging with the heat sink to limit movement of the circuit board along the axial direction of the heat sink;
a reflector arranged around the at least one LED; and
a lampshade mounted on the reflector to encapsulate the LED.

13. The LED lamp of claim 12, wherein each fin comprises two branches, and is one of V-shaped and Y-shaped.

14. The LED lamp of claim 12, wherein the branches of each fin are connected together at one end of the heat sink, and are spaced from each other at a portion of the heat sink other than the one end of the heat sink.

15. The LED lamp of claim 12, wherein each branch of each of the fins has a width being gradually increased along the axial direction of the heat sink.

16. An LED lamp comprising:
a heat sink having a substrate and a sidewall extending from a periphery of the substrate, a plurality of fins being extended outwardly from an outer surface of the side wall, each of the fins comprising at least two branches connected with each other at the outer surface of the side wall of the heat sink, the at least two branches having outer sides cooperatively forming a V-shaped configuration along an axial direction of the heat sink;
a printed circuit board received in the heat sink and seated on the substrate;
an LED electrically mounted on the printed circuit board, having an portion extending through the printed circuit board to thermally connect with the substrate of the heat sink.

17. The LED lamp of claim 16 further comprising a bracket mounted in the heat sink and on the printed circuit board, the bracket having a central hole through which the LED extends, and a plurality of securing posts extending through the printed circuit board and the substrate to engage with the heat sink, thereby fastening the bracket, the printed circuit board and the heat sink together.
